(19) United States
(12) Patent Application Publication
(10) Pub. No.: US 2015/0360062 A1
(43) Pub. Date: Dec. 17, 2015

(54) Personal Positioning Strap System

(71) Applicant: Edward Anthony OLIVER, Dana Point, CA (US)

(72) Inventor: Edward Anthony OLIVER, Dana Point, CA (US)

(21) Appl. No.: 14/737,448

(22) Filed: Jun. 11, 2015

Related U.S. Application Data
(60) Provisional application No. 62/010,848, filed on Jun. 11, 2014.

(51) Int. Cl. A62B 35/00; E06C 7/18

(52) U.S. Cl. CPC A62B 35/0025; E06C 7/18; A62B 35/0037

(57) ABSTRACT

A strap system to assist in supporting a person in a standing position and also to assist in a person's positioning and repositioning. Left and right straps can extend from the near waist, close to the hip on the left and the right side and terminate in hooks or clips for connection to the rungs of a ladder or other fixed component. At least one strap has a quick disconnect coupling and can have a breakaway coupling and can have a shock-absorbing portion.

### RELATED APPLICATIONS

This patent application claims the benefit of co-pending U.S. provisional application 62/010,848 filed on Jun. 11, 2014 by the same inventor; that application is also included here by reference in its entirety.

### FIELD

This disclosure relates to strap systems used to assist humans to safely remain in a position or to safely change positions.

### BACKGROUND

There are safety strap systems for a wide variety of applications including window washing, mountain climbing, offshore sailing, palm tree climbing, electric pole climbing, and many others. In general, equipment is optimized for one of these applications and may be unsuitable for another. Some straps are backup for a primary lift system, as is a window washing safety lanyard. Others are integral to the task, as is a strap for palm tree climbing. And still others assist in maintaining a position. For example, the life lines that run along the perimeter of many pleasure boats aren't intended to support a sailor's body weight, but can help steady someone moving along the boat.

The current teachings were initially motivated by a specific problem. Those that do have this and similar problems need a solution. One use for the apparatus discussed here is to assist people who need to safely steady and reposition themselves while on a ladder where safety is enhanced by an apparatus that assists in staying on the ladder, but where the apparatus does not hinder the person in cleanly, rapidly detaching from the ladder.

### SUMMARY

The problem of balancing a person in a generally standing position on a relatively slowly moving railcar at a point only a few feet from the ground is solved by a pair of straps that can be connected to apparel the person is wearing near the waist on either side of the person. The apparel can be a belt, safety vest, harness or other suitable structure. The straps can have hooks on their ends that can be attached to fixed positions. On one or both straps can be a user-operable quick disconnect coupling that allow the user to detach even under tension, there also can be a breakaway coupling that, at a predetermined force or tension, opens. This summary serves as a short introduction and does not necessarily cover all claimed aspects of these teachings.

### BRIEF DESCRIPTION OF THE FIGURES

FIG. 1 shows a view of a person on a ladder of a boxcar;

FIG. 2 shows the situation of FIG. 1 from an expanded view, permitting a view of a safety strap system on the person;

FIG. 3 shows the person on the ladder of FIG. 2 operating a remote-control box with one free hand;

FIG. 4 shows the person on the ladder of FIG. 2 with both hands free;

FIG. 5 shows the person of FIG. 2 off the ladder of FIG. 2 and standing on the ground with the safety strap system in a disconnected state;

FIG. 6 is a perspective view of an embodiment of a safety strap system positioned for connection to a ladder rung;

FIG. 7 is a perspective view of the safety strap system of FIG. 6 positioned in a stowed state, as around a user's waist;

FIG. 8 shows a rear view of a the safety strap system of FIG. 6 with the belt opened up to a flat state;

FIG. 9 shows a front view of a the safety strap system of FIG. 6 with the belt opened up to a flat state;

FIG. 10 shows an exploded view of the right portion of the safely belt of FIG. 6;

FIG. 11 shows a right side perspective view of the safety strap system of FIG. 6 in a demonstration of a user operating a quick-disconnect coupling

FIG. 12 shows the view of FIG. 6 for a second embodiment;

FIG. 13 shows the view of FIG. 10 for the second embodiment;

FIG. 14 shows the view of FIG. 11 for the second embodiment.

FIG. 15 illustrates a simple physical model that might be used in determining a breakaway force for a given application.

### DETAILED DESCRIPTION

### Overview of the Motivating Problem

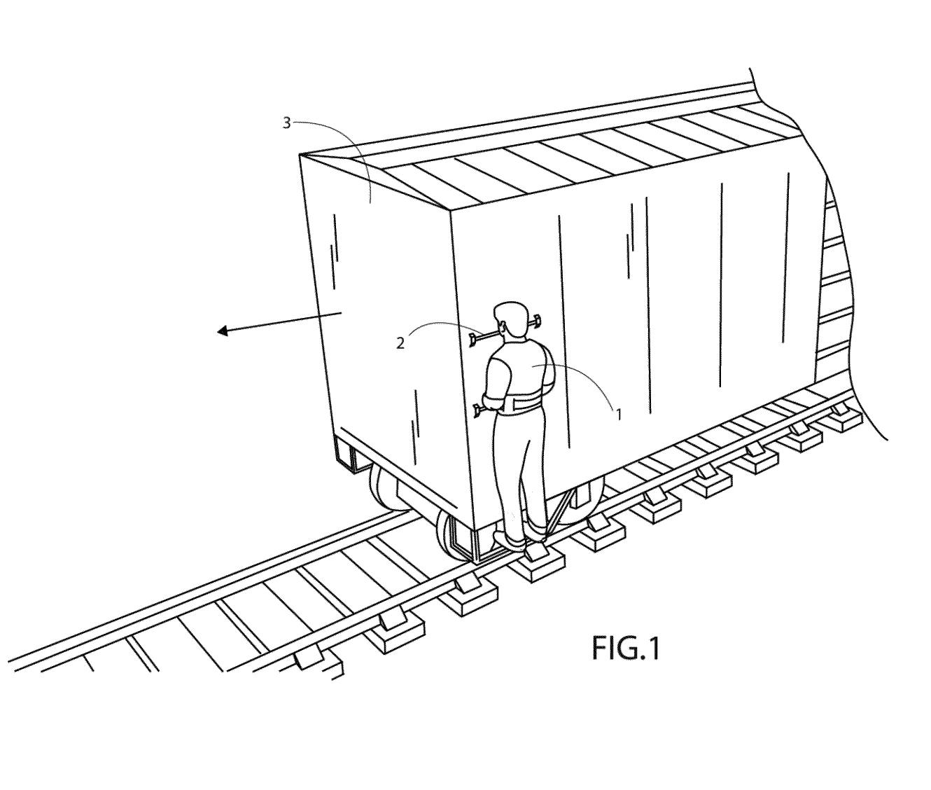

The setting that initially motivated the concepts of this disclosure is shown in FIG. 1. A person 1 is hanging on to a ladder 2 that is on the side of a boxcar 3. The boxcar is moving backwards and the end of the boxcar near the person is the end of the train. The person, a spotter, is watching the track to be sure it is safe to continue backing up. The cab at the front of the train, from where the train is usually controlled, might be one mile away or further from this end of the train. The spotter stands on a lower rung and holds on to a higher rung—preferably with both hands.

At the present, no strap system is routinely used to secure the person to the moving train. Unlike other applications of a safety strap, staying connected is important, but more important is being able to get disconnected quickly and cleanly in some emergencies. The person is not very high from the ground and, in the case of a spotter being deployed, the train isn't moving very fast. Jumping off, or falling off cleanly, is not terribly dangerous to the spotter. More worrisome is the case where the person is so well secured to the boxcar that they stay coupled during a derailment. Another dangerous case is awkwardly falling off in a non-symmetric manner or where the person is hung up on one side or the other. Those occurrences could lead to the spotter ending up under the train.

### Structure of a First Embodiment

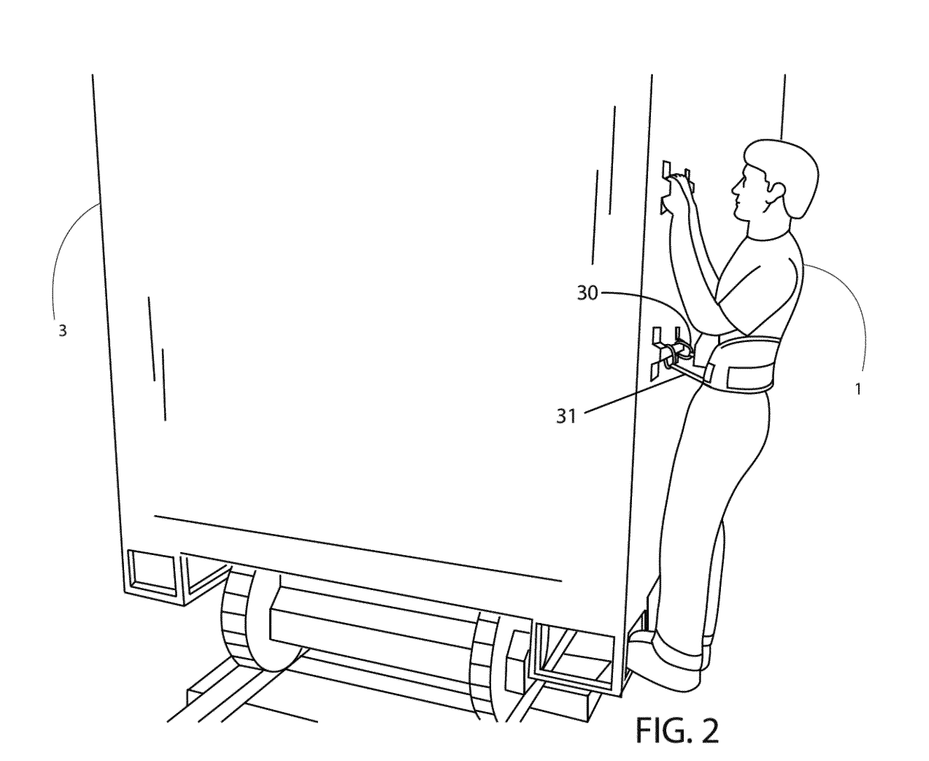

FIG. 2 shows a closer view of the spotter on the ladder. In addition to holding on to a ladder rung with both hands, the spotter is attached to a ladder rung by a safety strap 31 terminating in a hook 30 on a rung.

In some cases there is no one in the cab driving the train. The spotter, as seen in FIG. 3, may be using a remote control box 33 to operate the train—and may also, or alternatively, be talking on a radio (not shown here). In those cases, the safety method “just hang on tightly with both hands” will not be adequate.

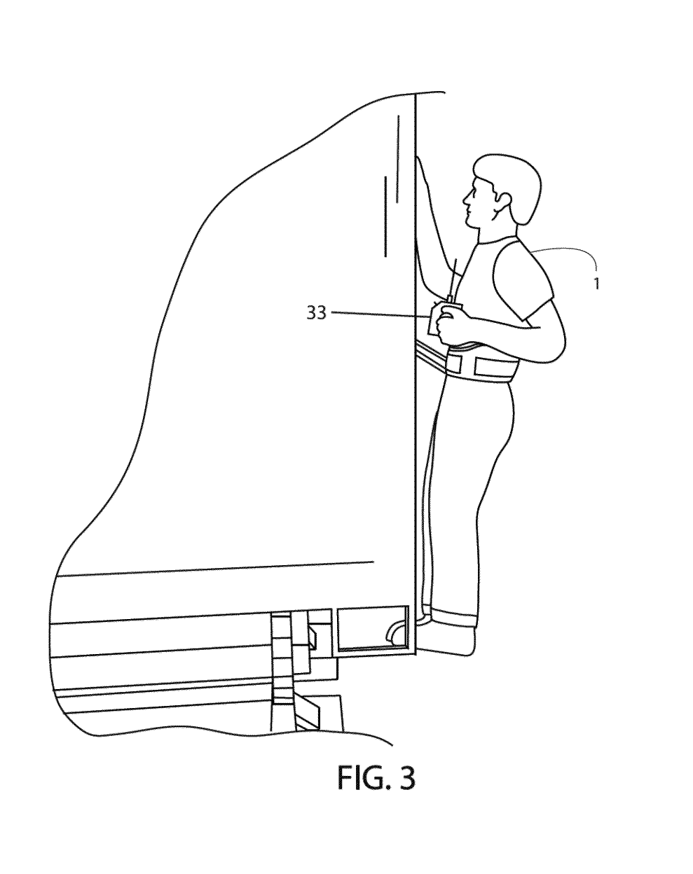

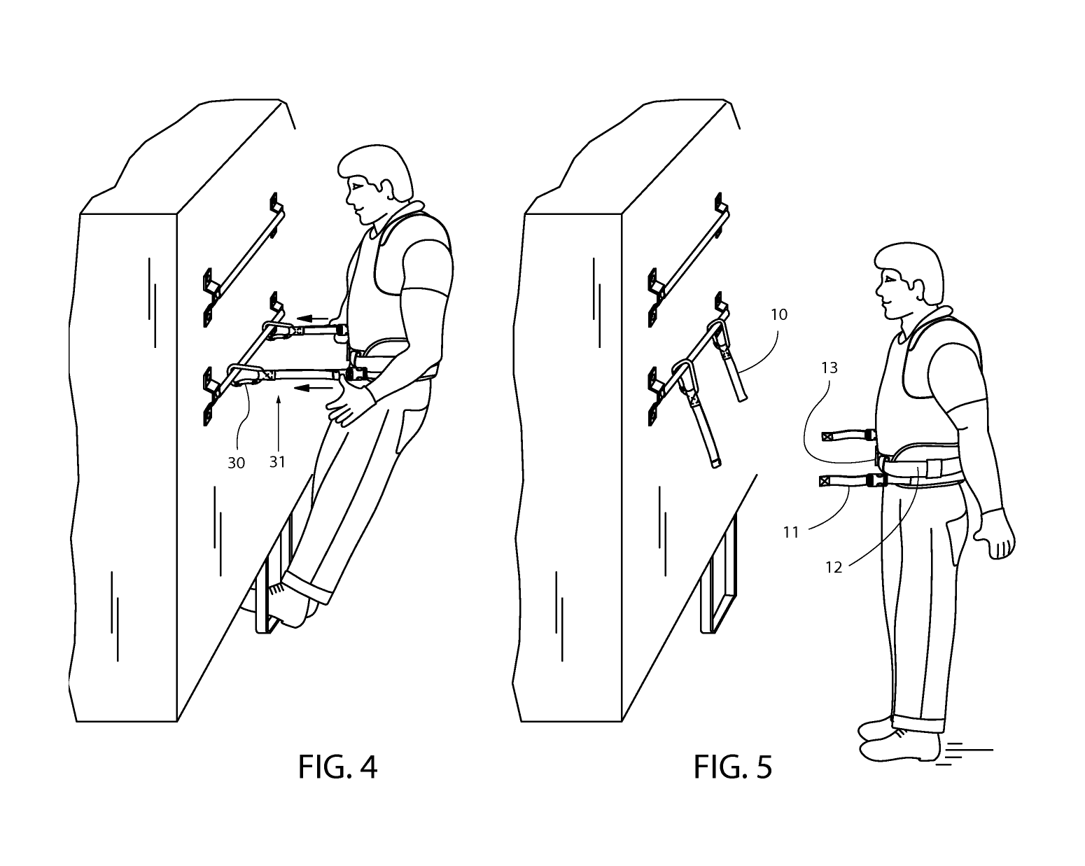

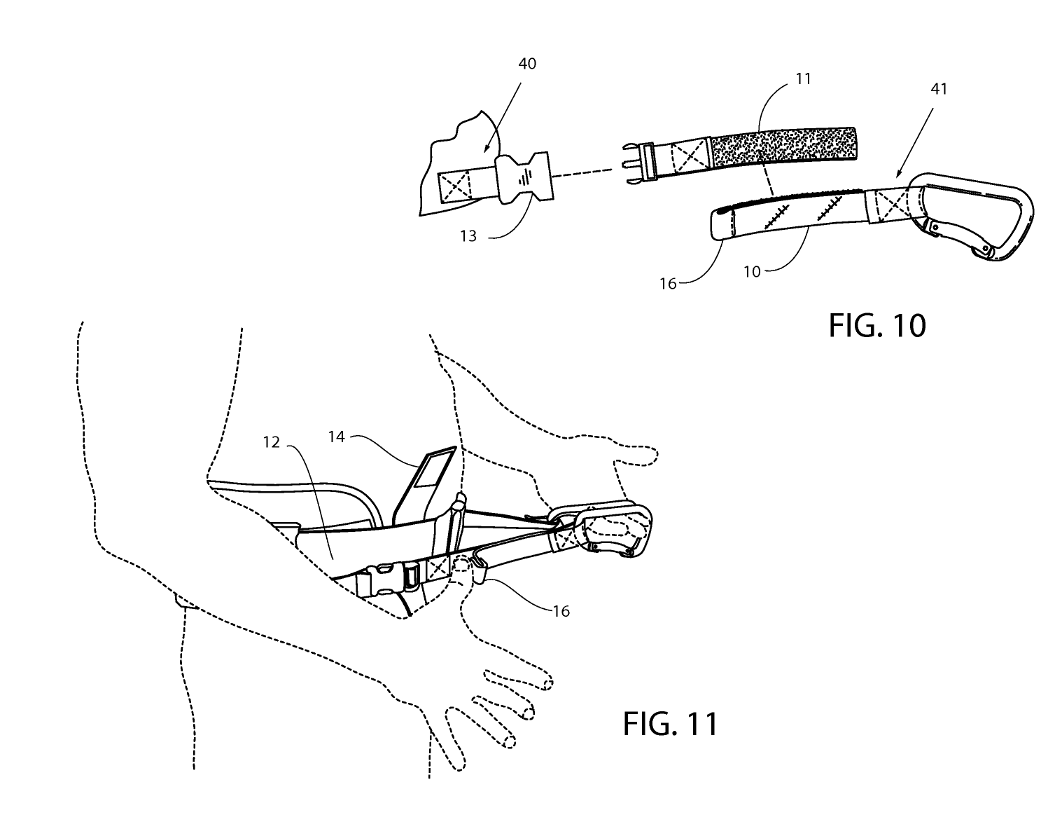

The next two figures (FIG. 4 and FIG. 5) show a person being secured to a ladder by the first embodiment strap system and in the process of cleanly disconnecting from that ladder. The user is opening the hook and loop quick disconnect using only his two thumbs in FIG. 4 and is seen safely on the ground in FIG. 5 with the straps each separated into two segments. One segment of the safety strap, the hook side 10, is still attached to the ladder and the person side 11 of the safety strap is still attached to the person. The two portions are coupled by hook and loop, best seen in FIG. 10 where they are disconnected and each stands alone. The person-side of the strap is secured to a belt 12 via a side-release buckle 13. In the version shown, the belt is a support belt.

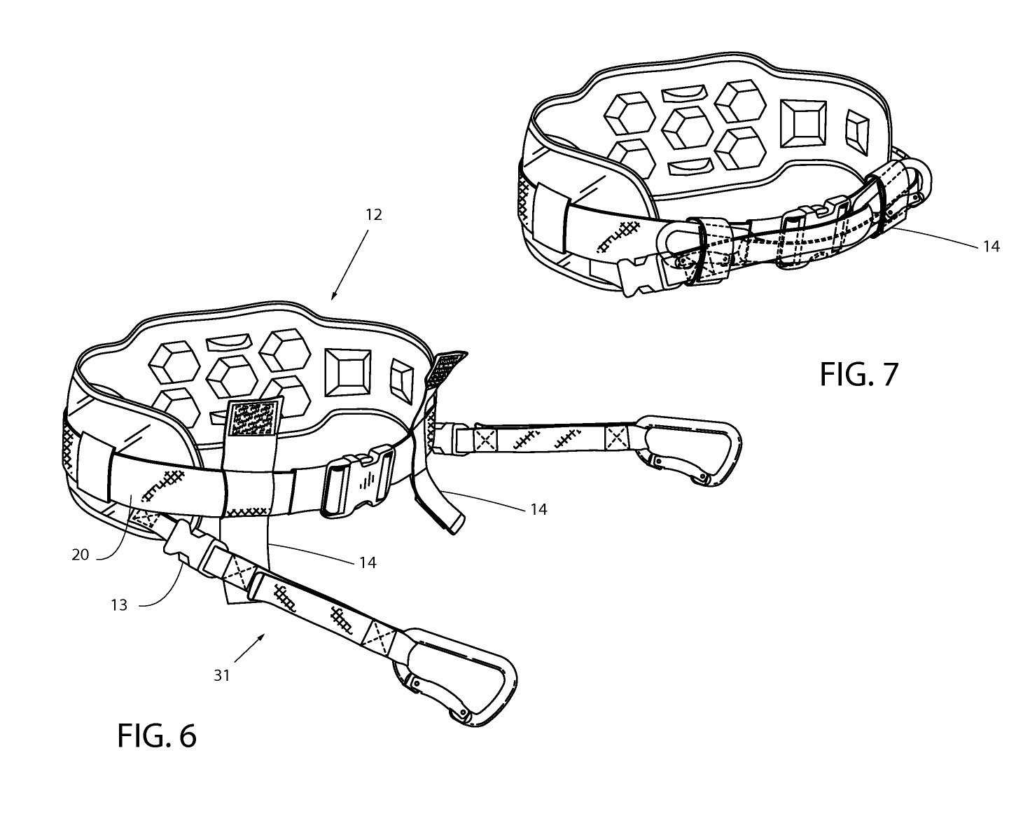

FIGS. 6 and 7 show the safety strap system alone and at an enlarged scale. The sub-components mentioned above are seen more clearly here. Features not yet mentioned, but seen clearly in these figures are the two (right/left) strap retainers 14. They are short straps at the front of the belt that are perpendicular to the belt proper. In FIG. 6 they are seen open, as they are when the safety strap system is in use. The function of these short straps is demonstrated in FIG. 7 where the safety strap system is not in use and the straps are partially wrapped around the user's waist. The upper and lower segments of the strap retainers go over the safety straps and connect to each other by hook and loop, retaining the safety straps in a comfortable position when not in use. This state is seen in FIG. 7. Another variation would be to use clips to hold the straps when wrapped partially around the user's waist rather than the short straps shown here. In use, the belt can be unbuckled so that it acts like a sling. In that configuration uncoupling either side's strap will disconnect the user from the ladder. While the belt shown in these figures shows a buckle, versions and embodiments can have no buckle. In that case, the belt acts more like a sling. If either strap disconnects, the person will be free.

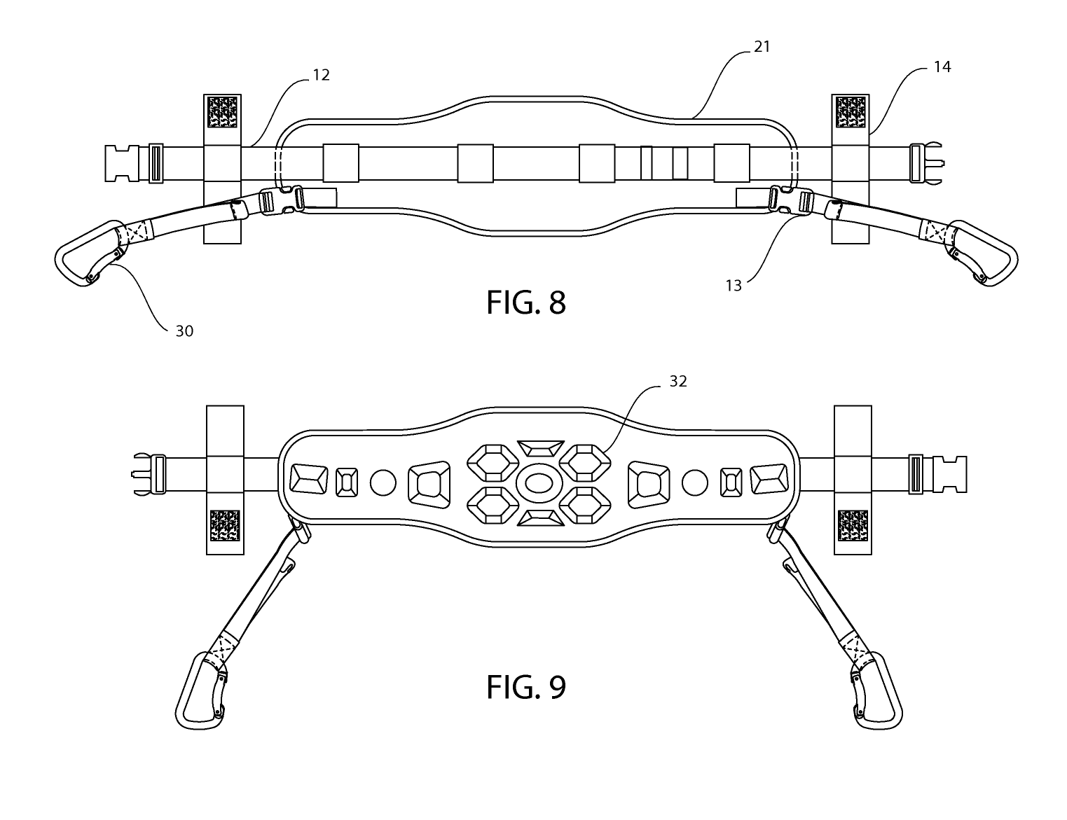

To more fully describe this first embodiment, FIGS. 8 and 9 show, respectively, the back and front of the complete safety strap system (including belt proper 12 and back support 21) fully spread out. The various symmetric sub-parts of the system including, hook-side segments, person-side segments, secondary coupling by side operated buckle, and strap retainers are seen in both figures. In FIG. 8, the rear side, it is clear that, in this embodiment, the belt has two parts, a belt proper 12 and a back support 21. The inside of the back support seen in FIG. 9 shows several foam structures 32 in various shapes. These structures can perform the function of making the belt more comfortable and specifically can create air space between the user's back and the back support.

### Variations

Many variations of these embodiments are contemplated. The belt proper can be integrated with the back support or can be a separate item. Some users may not wish to have a back support and would just use the belt proper in the case that they are separate parts.

The embodiments shown have two couplings in series on the safety straps, a hook and loop coupling and side operated buckle coupling. This provides a secondary means of detaching. In some versions, that level of redundancy may not be required or desired. A variation would be a system with only one or the other. And either or both couplings could be replaced by many other known quick disconnect couplings.

Also the hooks, shown as carabineers, can be of a different type of hook or connection. Carabineers have an advantage over some other connections if the user is moving between positions on the ladder frequently.

### Operation of First Embodiment

As mentioned, the first embodiment shown has a quick release on each side, operable with only the thumbs. The hook and loop coupling that this action opens is shown in more detail in FIGS. 10 and 11. FIG. 11 shows a user placing a thumb on a short, extending tab 16 of the hook and loop coupling. From that position a forward movement of the thumb, or of the whole hand, will disconnect the user from whatever the hooks are connected to. FIG. 10 shows an exploded view of one side's safely strap. It is actually not exploded, but rather, the segments are disconnected from each other, as happens in normal use, and are collectively disconnected from the belt. The figure shows the hook-side segment 10 detached from the person-side segment 11 and the person-side segment detached from the belt. The tab used to disconnect the segment is clearly seen in FIG. 11.

Operation would include attaching the left and right hooks to rungs of a ladder or other fixed features; releasing one or both hands for short periods of time while leaning back to be balanced by the strap connections; and, with one hand on a rung, moving one carabineer up or down a rung on the ladder and when secure, moving the other carabineer to that rung.

Another mode of operation is a deliberate detachment. In this version that can be done by thumbs pushing against the tab or by grasping both the top and bottom of the two side-operated buckles.

### Breakaway

A feature of some embodiments is a breakaway coupling in the series of couplings between hook and person. A breakaway coupling uncouples without user action if sufficient tension is applied to the strap. Since the ground is a short distance away, hitting the ground is preferable to hanging from the ladder and possibly being sucked under the train.

This benefit can be accomplished by one or more tension sensitive couplings that are designed to break away at a predetermined force. A workplace could have multiple safety strap systems set for different user weight ranges and possibly color-coded or otherwise clearly marked.

Hook and loop connections can be used to create a breakaway coupling. They can have a breakaway limit that, for a given hook fabric and a given loop fabric, is proportional to the area of mating. This property can be taken advantage of to construct safety strap systems with various breakaway tension limits.

### Second Embodiment

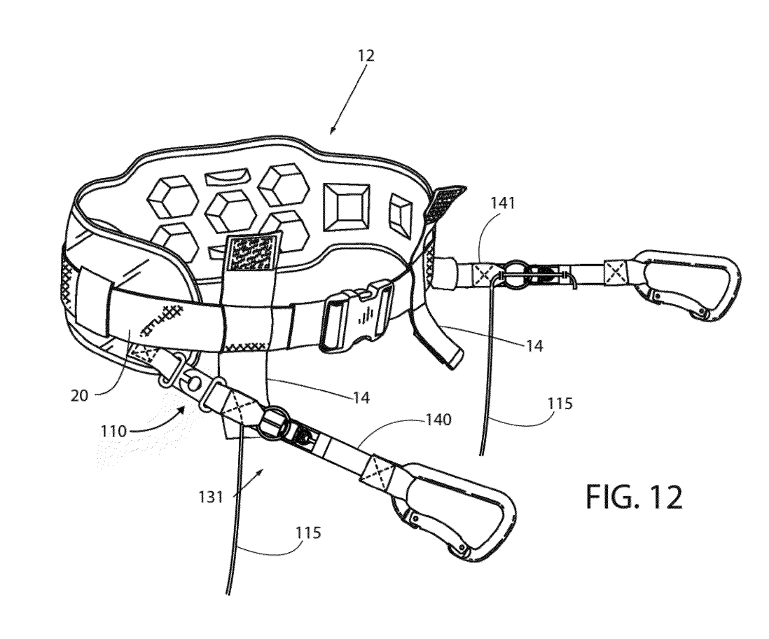

A second embodiment is shown in FIGS. 12, 13, and 14. FIG. 12 shows a perspective of the complete safety strap system of this embodiment. The quick disconnect mechanism is a 3-ring release 110 often used with used with parachutes. It is discussed in Parachute Release Apparatus and Method U.S. Pat. No. 6,056,242, Parachute Deployment System and Method U.S. Pat. No. 6,626,400 B1, and in U.S. Pat. No. 4,337,913A. A simple pull of the cords 115 releases the load-bearing belt 20 from the respective left and right side 140 portion of the strap connected to the hooks.

There are many other known quick-disconnect mechanical systems. Some examples are found in seat belt releases in both aircraft and automobiles.

In this embodiment, in series with the user-operated quick disconnect is a force or tension sensitive breakaway 110. In this second embodiment, the breakaway mechanism is patterned after one taught in U.S. Pat. No. 6,360,404. It has a cylindrical post on one side 150 and a buckle 151 with a slightly smaller than the diameter of the post such that the post is a friction fit with the slot. The material and fit determine the force at which the coupling breaks away.

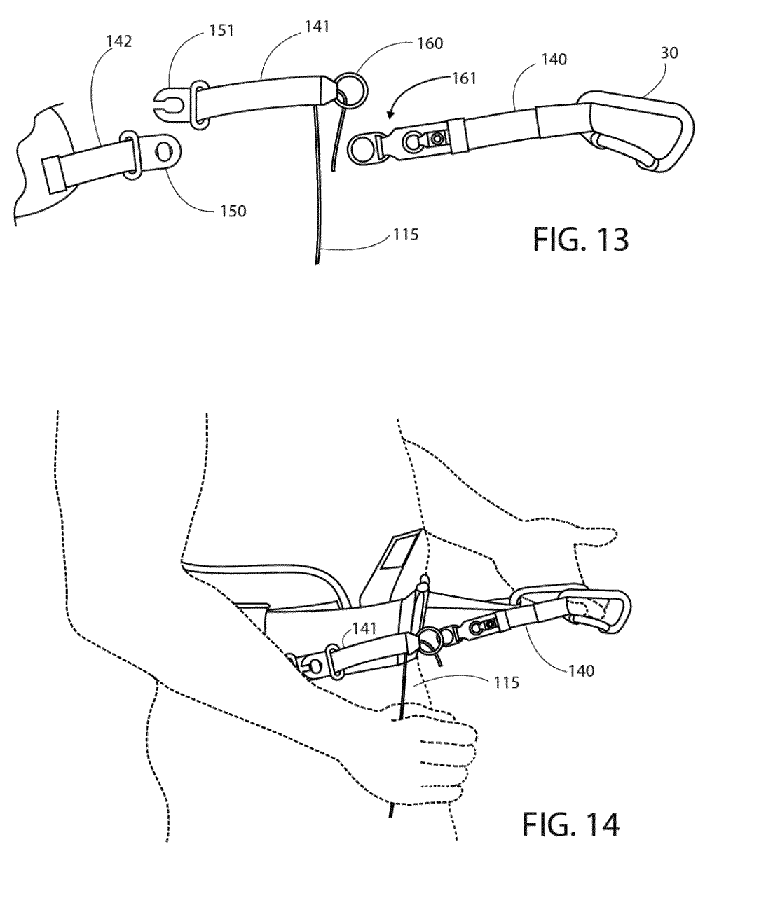

FIG. 13 shows the right side strap in its three distinct segments. The strap portion 140 closest to the hook has the hook at one end and two rings 161 of the 3-ring release at the other. The central portion 141 of the strap has the large ring 160 of the 3-ring release at one end and the slotted buckle side 151 of the breakaway connector at its other end. Last, directly connected to the belt is the final portion 142 that has the side of the breakaway connector with a post 150.

FIG. 14 shows the operation of the quick-release 3-ring mechanism. The user pulls the release cord 115 that allows the 3-ring mechanism to release and separate 141 and the hook-side portion 140.

### Variations

Again, there are many known mechanisms that provide an automatic disconnect function when force or tension reach a predetermined level. Some examples of this involve disconnecting fluid conducting hoses. While no fluid is being transferred in this application, many of the mechanisms could serve the purpose of a breakaway connection in this application. One example is seen in Break-Away Coupling with Spaced Weakened Sections U.S. Pat. No. 5,474,408. Although intended for use in guy wires to allow a telephone pole to fall when hit by an automobile, the principle of a frangible region could apply to the context of these teachings. A frangible breakaway coupling would actually break and therefor be a one-time use mechanism.

### One Approach to Determining a Desired Breakawa Force

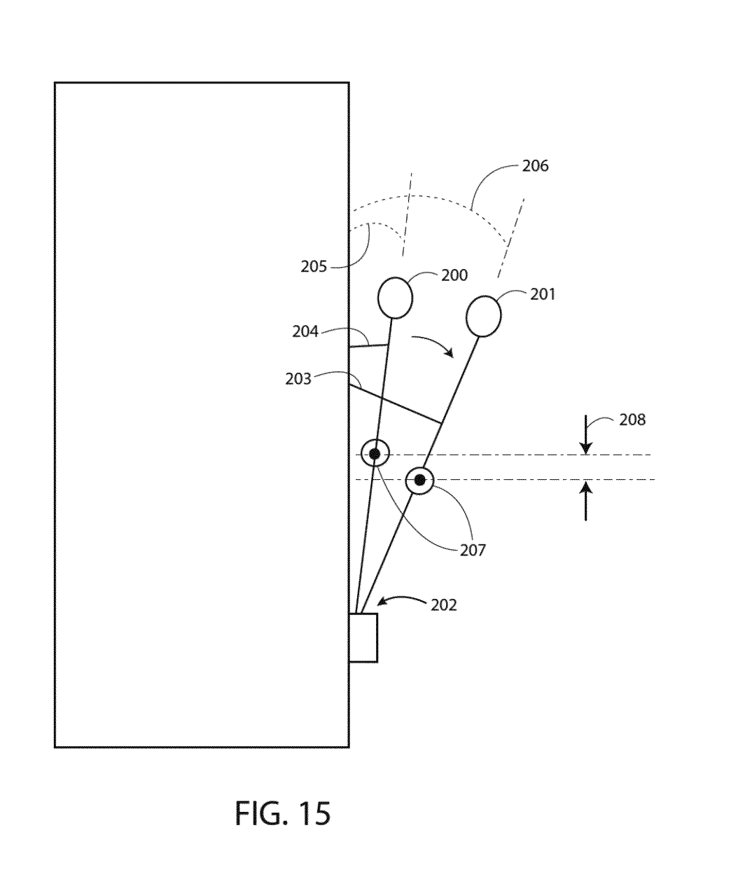

FIG. 15 illustrates a very simple mechanical model showing some factors that may be considered when determining a breakaway point. It is laid out to model the case of a person loosing their grip on a ladder, but with feet still on a rung. The person would “fall” from a generally upright stance 200 on the ladder supported from rungs by their arms 204 to one where the feet position 202 do not change but the body is leaning out 201 to the extent provided by the length of the strap 203 and the location of the rung it is hooked on to. A person might go from smaller angle 205 (1 to 4-degrees for example) of a person in a normal position, to a larger angle 206 (about 10-degrees for example) to the ladder if one or both hands lose their grip and the person where supported by the straps and their feet. Losing grip causes a peak strap tension that is the sum of the momentum of the short fall and a portion of the body weight due to the effective sine of the extended angle. The dynamic forces of a strap-supported fall could be modeled by the person's center of gravity 207 free falling a calculated or estimated distance 208. Also the larger angle 206 would result in a higher percentage of the mass of the person being affected by gravity.

In some applications it might be desirable for that occurrence to produce forces below the breakaway force. In the case of the user dropping due to one or both hands and the user's feet coming off the ladder, it might be desirable for the force to be above the breakaway force.

### Variations

Other breakaway technologies with more precision could be used and, if in series with a quick disconnect coupling, could be a one-time use coupling. A one-time use breakaway coupling can have the advantage of a more precise and narrow range of required breakaway force. In the case of a coupling calibrated for a single use, a seal can act as an indicator that a use has occurred.

### Shock Absorption

In some embodiments, it is desirable to add a segment of elastic webbing in series with the quick-disconnect coupling. This can act as a shock absorber with multiple benefits. A degree of resiliency in the connection between hook and person can improve the comfort of the person as they stand and relocate in a windy environment and on a moving railroad car. Also, while a breakaway facility can be important for safety, it may be undesirable for a short-lived jerk to invoke breakaway. A degree of resilience can smooth out the forces to avoid a breakaway under normal conditions. FIG. 10 shows two points in the strap of the first embodiment where an elastic segment might be inserted. One point 40 is close to the connection to the person and another 41 is close to the hook.

The embodiments described and pictured, as well as the variations mentioned, are only examples of devices consistent with these teachings. Only claims indicate aspects of the claimed invention.

It is claimed:

1. A strap system comprising:
a right and a left strap each with a proximal terminus adapted to couple to a person's apparel at the waist near the hip and with a hook at the distal terminus, the length of the two straps each being about one forth of the height of a person, at least one of the two straps having a quick-disconnect coupling readily operable by the coupled person.

2. The strap system of claim 1 where at least one of the two straps has a breakaway coupling.

3. The strap system of claim 2 where the breakaway coupling and the quick disconnect coupling are distinct from one another.

4. The strap system of claim 1 further comprising a belt adapted to hold the safety straps around a user at the user's hips when the user is in a standing position.

5. The strap system of claim 4 where the belt is a body belt with back support.

6. The strap system of claim 4 further comprising short straps at the left and right front of the belt perpendicular to the belt that are adapted to hold the straps when wrapped around the users waist in a stowed position.

7. The strap system of claim 1 further comprising a resilient, shock absorbing, segment.

8. The strap system of claim 4 where the belt comprises a buckle mechanism to hold the belt to the user in any user position.

9. A method of repositioning on a ladder of equipment in motion comprising, using a strap system of claim 1, the actions:
attaching a first strap to a ladder rung;
attaching the second strap to a rung;
unbuckling the belt

10. The method of claim 9 where at least one strap has a breakaway coupling.

11. The method of claim 9 further comprising the action:
releasing both hands while maintaining feet position, thereby engendering a leaning outward of the user while being held to the ladder by the strap system.
